(19) United States
(12) Patent Application Publication
(10) Pub. No.: US 2023/0325481 A1
(43) Pub. Date: Oct. 12, 2023

(54) Method and System for Authentication of a Subject by a Trusted Contact

(71) Applicant: Lever Dynamics LLC, New York, NY (US)

(72) Inventor: Jonathan C. Clay, Zurich (CH)

(21) Appl. No.: 17/940,205

(22) Filed: Sep. 8, 2022

Related U.S. Application Data
(60) Provisional application No. 63/328,361, filed on Apr. 7, 2022.

(51) Int. Cl. G06F 21/32; G06V 40/20

(52) U.S. Cl. CPC G06F 21/32; G06V 40/20

(57) ABSTRACT

A method for authentication of a subject by a trusted contact includes: prompting the subject to perform a set of actions; receiving a set of video recordings of the subject performing the set of actions; storing the set of video recordings in a database; transmitting an authentication request to a computing device of the trusted contact; in response to receiving an acceptance of the request, displaying the set of video recordings on the computing device of the trusted contact together with a set of authentication evaluation requests to evaluate an authenticity of each one of the set of video recordings; receiving a set of authentication evaluation responses from the computing device of the trusted contact, each one of the set of authentication evaluation responses responsive to an authentication evaluation request of the set of authentication evaluation requests; determining an authentication result based on the set of authentication evaluation responses.

### PRIORITY

This application claims priority from U.S. Provisional Application 63/328,361, filed on Apr. 7, 2002, which is hereby incorporated herein, in their entirety, by reference.

### TECHNICAL FIELD

The present invention relates to authentication of an individual, and more particularly to authentication of an individual by a trusted contact of the individual.

### BACKGROUND ART

The positive identification of an individual is of critical importance in many areas of life. Unauthorized access to sensitive information such as financial accounts, health records, or legal documents, can have extremely damaging repercussions to a person's life, livelihood, and reputation. Accordingly, there is strong motivation to keep such information well protected.

In general, there are four categories of ways to authenticate a person: by testing what they know, such as a password; by testing what they have, such as a hardware device that provides unique synchronized codes; by testing what they are, meaning biometric data such as fingerprints and facial structure; and by testing who knows them, i.e. asking a work colleague or family member, etc. to “vouch” for them.

In a scenario where someone needs to be authenticated, for example to gain access to a device or log in to an account, it is typical to combine one or more of the above checks into a multi-step procedure in order to provide a higher degree of assurance that the person is who they claim to be. For example, one may be asked to enter a password, and subsequently asked to answer secondary security questions, such as “what is your mother's maiden name?”, or “what are the last four digits of your account number?” Or one may be sent a code via email or text message/SMS to verify that one is in possession of a device that is capable of receiving it. Such techniques are known as two-factor authentication (2FA) or multi-factor authentication (MFA). They greatly improve the chances of defeating attempts at identify theft. However, they are far from foolproof, because information such as a password or mother's maiden name is relatively easy to guess or obtain. Even biometric data such as facial images and fingerprints can be copied and mimicked. Furthermore, if a device such as a computer or mobile phone is stolen, it is relatively easy for the thief to confirm a code that has been sent to it.

### SUMMARY OF THE EMBODIMENTS

In accordance with one embodiment of the invention, a computer-implemented method for authentication of a subject by a trusted contact includes processes carried out by a server system. The processes include causing, by the server system, prompts to the subject to perform a set of actions, each action in the set of actions selected from the group consisting of stating a current date, stating a current time, stating a name of the subject, stating a current location of the subject, stating information known to the subject and the trusted contact, stating a phrase, performing a hand gesture, performing a head or body movement, and combinations thereof. The processes also include receiving, by the server system, video data, the video data including a set of video recordings of the subject performing the set of actions. The processes include storing, by the server system, the set of video recordings in a database. The processes further include transmitting, by the server system to a computing device of the trusted contact, an authentication request. In response to the server system receiving an acceptance of the authentication request from the computing device of the trusted contact, the processes include causing display, by the server system on the computing device of the trusted contact, of the set of video recordings retrieved from the database together with a set of authentication evaluation requests to evaluate an authenticity of each one of the set of video recordings. The processes also include receiving, by the server system from the computing device of the trusted contact, a set of authentication evaluation responses, each one of the set of authentication evaluation responses responsive to an authentication evaluation request of the set of authentication evaluation requests. The processes further include determining, by the server system, an authentication result based on the set of authentication evaluation responses.

Alternatively or in addition, determining an authentication result includes calculating, by the server system, a confidence score based on the set of authentication evaluations.

Alternatively or in addition, the receiving video data including the set of video recordings of the subject and the causing display of the set of video recordings on the device of the trusted contact is performed substantially in real-time.

Further alternatively or in addition, the server system causes the prompts to the subject to perform a set of actions to be displayed on a computing device of the subject. Also alternatively or in addition, the server system causes the display of the prompts by use of a virtual assistant executing on the computing device of the subject.

Alternatively or in addition, the server system transmits the authentication request to a virtual assistant executing on the computing device of the trusted contact. Further alternatively or in addition, the method for authentication includes prompting, by the virtual assistant executing on the computing device of the trusted contact, the trusted contact to accept the evaluation request.

Alternatively or in addition, the server system causes the display of the video recordings retrieved from the database on the computing device of the trusted contact by use of a virtual assistant executing on the computing device of the trusted contact. Also alternatively or in addition, the server system causes the display of the set of authentication evaluation requests by use of a virtual assistant executing on the computing device of the trusted contact. Further alternatively or in addition, the server system receives the set of authentication evaluation responses from a virtual assistant executing on the computing device of the trusted contact.

In accordance with another embodiment of the invention, a system for authentication of a subject by a trusted contact includes a server system including a processor, the server system coupled to a database, the server system further coupled to a computing device of the trusted contact over a network. The processer is configured to cause prompts to the subject to perform a set of actions, each action in the set of actions selected from the group consisting of stating a current date, stating a current time, stating a name of the subject, stating a current location of the subject, stating information known to the subject and the trusted contact, stating a phrase, performing a hand gesture, performing a head or body movement, and combinations thereof. The processor is also configured to receive video data, the video data including a set of video recordings of the subject performing the set of actions. The processor is further configured to store the set of video recordings in the database. The processor is also configured to transmit, to the computing device of the trusted contact, an authentication request. In response to receiving an acceptance of the authentication request from the computing device of the trusted contact, the processor is configured to cause display, on the computing device of the trusted contact, the set of video recordings retrieved from the database together with a set of authentication evaluation requests to evaluate an authenticity of each one of the set of video recordings. The processor is also configured to receive, from the computing device of the trusted contact, a set of authentication evaluation responses, each one of the set of authentication evaluation responses responsive to an authentication evaluation request of the set of authentication evaluation requests. The processor is further configured to determine an authentication result based on the set of authentication evaluation responses.

Alternatively or in addition, determining an authentication result includes calculating a confidence score based on the set of authentication evaluations.

Also alternatively or in addition, the processor is configured to receive video data including the set of video recordings of the subject and to cause display of the set of video recordings on the device of the trusted contact substantially in real-time.

Further alternatively or in addition, the system further comprises a computing device of the subject coupled to the server system over the network and the processor is configured to cause the prompts to the subject to perform a set of actions to be displayed on the computing device of the subject. Also alternatively or in addition, the system further comprises a virtual assistant executing on the computing device of the subject and the processor is configured to cause the display of the prompts by use of the virtual assistant executing on the computing device of the subject.

Alternatively or in addition, the system further comprises a virtual assistant executing on the computing device of the trusted contact. Alternatively or in addition, to transmit the authentication request to the virtual assistant executing on the computing device of the trusted contact the processor is configured. Also alternatively or in addition, the processor is further configured to cause a prompt, by the virtual assistant executing on the computing device of the trusted contact, to he trusted contact to accept the evaluation request. Further alternatively or in addition, the processor is configured to cause the display of the video recordings retrieved from the database by use of the virtual assistant executing on the computing device of the trusted contact. Alternatively or in addition, the processor is configured to cause the display of the set of authentication evaluation requests by use of the virtual assistant executing on the computing device of the trusted contact. Alternatively or in addition, the processor is configured to receive the set of authentication evaluation responses from the virtual assistant executing on the computing device of the trusted contact.

### BRIEF DESCRIPTION OF THE DRAWINGS

The foregoing features of embodiments will be more readily understood by reference to the following detailed description, taken with reference to the accompanying drawings, in which:

FIG. 1 is a block diagram of an authentication method in accordance with an embodiment of the present invention;

FIG. 2 is a block diagram of a method for selecting an authentication mode in accordance with an embodiment of the present invention;

FIG. 3 is a block diagram of a method for facilitated authentication video capture and review in accordance with an embodiment of the present invention;

FIG. 4 is a block diagram of an authentication system in accordance with an embodiment of the present invention; and

FIG. 5 is a block diagram of an authentication method in accordance with an embodiment of the present invention.

### DETAILED DESCRIPTION OF SPECIFIC EMBODIMENTS

Definitions. As used in this description and the accompanying claims, the following terms shall have the meanings indicated, unless the context otherwise requires:
A “set” includes at least one member.
“Protected Material” includes data that is of a sensitive nature, which is only intended to be viewed or managed by authorized individuals. Protected Material includes accounts such as user accounts or accounts at financial institutions, but also sensitive data such as health records, legal documents, etc.
A “Subject” is an individual to whom Protected Material belongs or pertains.
A “Custodian” is an entity that is responsible for safekeeping and maintenance of Protected Material. Examples of a Custodian are a financial institution, a medical provider, and a government authority.
A “Trusted Contact” is an individual who is well known to the Subject from regular in-person interaction. Examples of a Trusted Contact are a coworker, a life partner, a family member, and a close friend.
A “Contact Method” is a method of contacting an individual that is generally considered to be secure, because the individual is assumed to have sole access to messages conveyed via a designated communication channel. Examples of a Contact Method are an email to the individual's email address, a text message to the individual's telephone, a call to the individual's telephone, or a dedicated hardware device that the individual is in possession of.
A “Third Party” is a person unknown to the Subject, such as a worker in a call center or a freelance contractor, whose purpose it is to provide verification services.
An “Authentication Agent” is a Trusted Contact or a Third Party who has been selected to perform identity verification of the Subject in order for the Subject to gain access to Protected Material.

This disclosure addresses the shortcomings of prior art authentication methods and systems by providing an additional type of verification check, which is based on review of one or more sequences of video and accompanying audio, as captured in a secure manner by a device in possession of an individual to be authenticated. This technique, in place of or in addition to other authentication methods, greatly improves the efficacy of authentication and reduces the chances of identity theft.

The capture of the video is facilitated by a virtual assistant in such a way that it defeats attempts at impersonating the user via “spoofing” or “deepfake” techniques. It goes beyond simple facial recognition and validates the individual's identity by analyzing their gestures, movements, speech patterns, and so on.

The review of the video may be performed in a fully automated manner, and/or by a human agent, depending on the requirements of the use case. If a human is involved, the review session is facilitated by a virtual assistant similar to the one used during capture. The capture and review processes are synchronized with each other by way of metadata regarding the content of the video corresponding to specific points along its timeline.

In some embodiments, a system for authentication has the following components:
An Authentication Server that is a system component whose purpose it is to coordinate authentication requests between Custodian, Subject, and Trusted Contact/Authentication Agent. The Authentication Server includes one or more server systems hosted in a secure data center.
A database that is a sub-component of the Authentication Server that provides persistent storage of data, including information about Custodians, Subjects, and Trusted Contacts/Authentication Agents, as well as video data and metadata. It is expressly noted that the meaning of the term “database” as used in this description and the accompanying claims is not limited to a dedicated database system, but includes any persistent, non-volatile storage of data, examples of which are a local or networked file system, a cloud storage service, and a blockchain.
An Application Programming Interface (API) that allows the parties involved in an authentication session to communicate securely with the Authentication Server. Communication with the API is secured via encryption and limited to designated sources, for example restricting certain function calls to Custodians that originate from known IP addresses and identify themselves with shared secret keys.
An End-User Application (EUA) that is built for supporting the authentication process, with the end user being a Subject or Trusted Contact/Authentication Agent. It may be a dynamic web application that is served by a web server from a URL, intended to run inside the end user's web browser. Alternatively, it may be a standalone application consisting of compiled or interpreted code, intended to run natively in the operating system of a device such as a personal computer or a mobile phone. Alternatively it may be an embeddable module consisting of compiled or interpreted code intended to be integrated into an enclosing application developed by the Custodian.
A Virtual Assistant (VA) that is a sub-component of the EUA that prompts the Subject and the Trusted Contact/Authentication Agent to perform actions such as speaking or moving. The VA also allows the Subject and the Trusted Contact/Authentication Agent to enter and send text messages to one another. The VA may have the typical appearance of a “chat bot” with displayed text messages and/or may be a simulation of a person or animated figure, with artificially generated speech. The VA may also make use of icons or other symbols to prompt the user to take certain actions. The VA may appear adjacent to video of the Subject, or may be superimposed on it. In addition, the VA may cause display of the video of the subject. The VA may also prompt the trusted contact to respond to and/or accept an incoming authentication request.

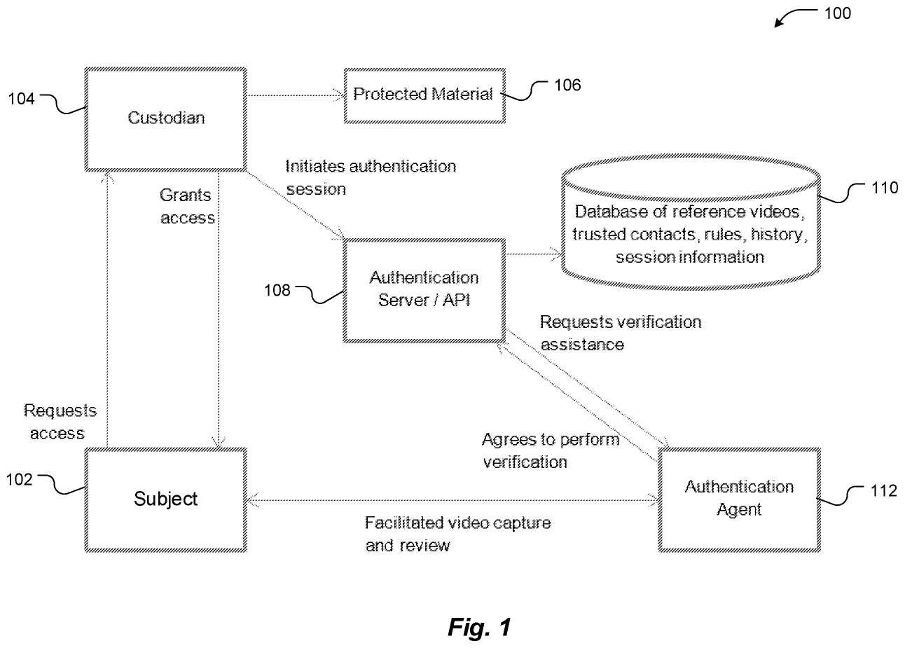

FIG. 1 is a block diagram of an authentication method 100 in accordance with an embodiment of the present invention. The method 100 can be used as a primary means of authentication, or in combination with others as part of an MFA sequence. In either case, the method is identical.

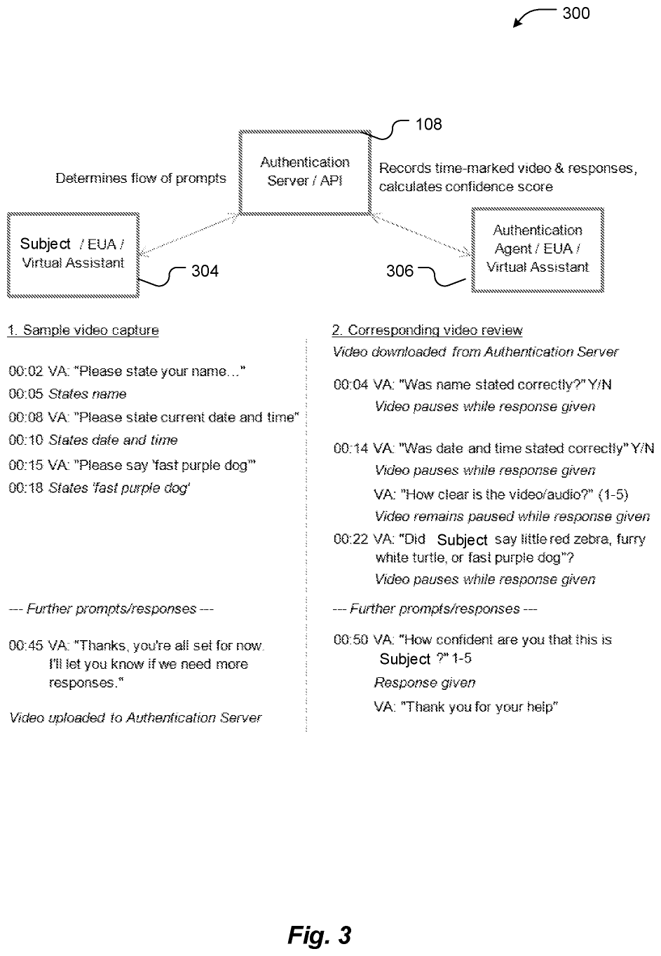

Custodian 104 and Subject 102 have a pre-existing relationship. As part of the administration of this relationship, the Subject may have agreed to authentication by automated and/or Third Party analysis. In this case, the Subject is asked to record a video that is used for reference purposes. The capture of this video is described in detail below with reference to FIG. 3.

Also as part of the administration of this relationship, the Subject may have agreed to enable contact-based authentication. In this case, the Subject is asked to provide information about one or more Trusted Contacts, with a name and Contact Method provided for each. Each Trusted Contact affirms that they are willing to act in this capacity before they are eligible to act as an Authentication Agent for the Subject. In addition to providing identifying information about Trusted Contacts, the Subject may specify authentication rules such as “always ask a trusted contact to authenticate me during login,” or “at least two contacts must authenticate me to access my account.” There may also be a secret word or phrase, shared between the Subject and the Trusted Contact, that is required for authentication to be successful.

The information about Trusted Contacts provided by the Subject 102 and any authentication rules specified by the Subject 102 are transmitted from a computer system of the Custodian 104 via a set of API calls to an Authentication Server 108, which then saves them in a database 110. This information may be updated periodically by the Subject 102, via the Custodian 104, by making a set of API calls.

When the Subject 102 wishes to gain access to Protected Material 106, they submit a request with the Custodian 104 via a web site, mobile application, or any other type of computer program. Any initial qualification tests, such as a password, are applied first. If, after applying the initial tests, the Custodian determines that the Subject has not yet matched a verification threshold, for example because the Subject is using an unrecognized device or IP address, or because the Subject has specified in an authentication rule that contact-based authentication always should be applied, the process continues before the Subject is granted access to the Protected Material 106.

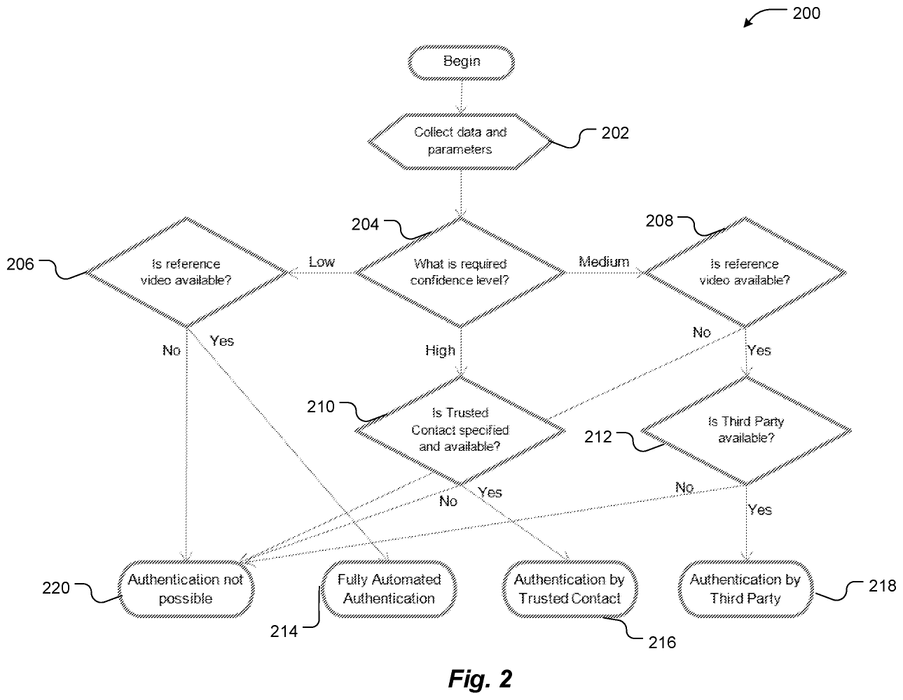

The computer system of the Custodian 104 makes a set of API calls to the Authentication Server 108, indicating that the Subject 102 needs to be authenticated. The Authentication Server 108 initiates an authentication session and determines the appropriate authentication mode, i.e. which type of video review is applicable. This determination depends on the use case, parameters specified by the Custodian, the Subject's preferences or specified authentication rules, availability of reference video, and availability and willingness of a Third Party and/or a Trusted Contact to perform review. The different authentication modes and a method for determining the appropriate authentication mode are described in detail below with reference to FIG. 2.

The Authentication Server 108 then causes capture of the authentication video. This process and the corresponding review by an Authentication Agent is described in detail below with reference to FIG. 3.

When the authentication video capture is complete and the video has been transmitted to the Authentication Server 108, the authentication system undertakes some or all of the following steps:
Automated quality control of the video. This step checks the video to determine if it meets minimal standards of integrity such as sufficient resolution (pixel count) and frame rate, proper lighting, the subject being visible and centered, audio being loud enough to be heard clearly, etc. If minimal quality standards are not met, the Subject may be asked to recalibrate and restart the video capture step. This technical analysis and feedback may also take place in real time as the video is being recorded. The processes that perform this analysis run on the Authentication Server, in the EUA, or a combination of both.
Automated technical analysis of video content. This step uses standard technologies to perform voice and object recognition on the authentication video and accompanying audio, for the purpose of identifying basic problems such as the Subject not speaking their name properly, or not looking up when requested to do so, or not correctly stating the unique phrase associated with the authentication session. While this step does not prove or disprove identity, it can be used to flag issues with the structure and content of the video that may result in a rejection. The processes that perform this analysis run on the Authentication Server, in the EUA, or a combination of both.
Automated comparison of authentication video versus reference video (if reference video is available). This step uses standard technologies to perform voice and object recognition on the authentication video and accompanying audio, as well as the reference video and accompanying audio, for the purpose of comparing the two representations of the Subject. Assessments may be made about how closely the videos match when comparing features such as facial structure, eye color, hair style, voice attributes, etc. The processes that perform this analysis run on the Authentication Server.
Human review by Authentication Agent (Third Party or Trusted Contact). This step is described in detail below with reference to FIG. 3.

The output of the one or more of the above steps that have been performed may be a percentage-based score that represents the level of confidence that the Subject's identity has been positively verified.

If the resulting confidence score is above a minimum threshold (e.g. 75%), which has been predetermined by the Custodian, the authentication is considered successful and complete. If the score is below the threshold, Subject may be denied access to the Protected Material, or the process may iterate until the necessary criteria have been met.

Once the minimum threshold has been met, the Subject is considered to be successfully authenticated, and the Authentication Server conveys a secure message back to the computer system of the Custodian indicating that the Subject may be granted access to the Protected Material, or that further verification checks may be performed if applicable.

### Selecting an Authentication Mode

FIG. 2 is a block diagram of a method 200 for selecting an authentication mode in accordance with an embodiment of the present invention. In step 202, the Authentication Server 108 collects data and parameters about the desired authentication from database 110 or from a set of API calls that have been made from the computer system of the Custodian 104 and/or the computer system of the Subject 102. In step 204, the server 108 determines, based on this collected data, what the required confidence level for the authentication is. If the required confidence level is low, the server proceeds to step 206. If the required confidence level is medium, the server proceeds to step 208. If the required confidence level is high, the server proceeds to step 210.

In step 206, for a low confidence level, the server determines if reference video is available, for example in the database 110. If such video is not available, authentication is not possible, and the method ends at step 220. If reference video is available, the Authentication Server 108 performs a fully automated authentication in step 214. This mode does not require any human intervention. It is applicable in situations where a relatively low level of confidence is required, as it depends purely on artificial intelligence which may not be able to discriminate nuances in manipulated videos.

In step 208, for a medium confidence level, the server determines if reference video is available, for example in the database 110. If such video is not available, authentication is not possible, and the method ends at step 220. If reference video is available, the server determines in step 212 if a Third Party is available as an Authentication Agent. If no Third Party is available, authentication is not possible, and the method ends at step 220. If a Third Party is available, the Authentication Server 108 performs an authentication by Third Party in step 218. This mode requires the Third Party to act as an Authentication Agent and is further described in detail below. It is applicable in situations where a medium level of confidence is required, as it uses human intelligence to look for possible signs of fraud, yet does not invoke personal memories of experiences with the Subject.

In step 210, for a high confidence level, the server determines if a Trusted Contact has been specified and is available as an Authentication Agent. If no Trusted Contact is available, authentication is not possible, and the method ends at step 220. If a Trusted Contact is available, the Authentication Server 108 performs an authentication by Trusted Contact in step 216. This mode requires the Trusted Contact to act as an Authentication Agent and is further described in detail below. It is applicable in situations where a high level of confidence is required, as it utilizes both human intelligence and personal familiarity with the Subject in determining whether the video confirms the Subject's identity.

### Reference Video Capture

The purpose of the reference video is to allow comparison of a Subject's video that has been captured for authentication purposes with baseline attributes determined from the reference video, such as facial features, voice timbre, etc. Comparison of features extracted from the reference video to an authentication video may be performed by automated software and/or by an Authentication Agent who may or may not have a personal relationship with the Subject. If the Authentication Agent is a Trusted Contact, the reference video is not required.

The reference video is captured with guidance from the VA that is executing in the Subject's EUA. During recording of the reference video, the VA prompts the Subject to perform actions such as, for example: state your full name; turn to the left/ right; look up/down; move closer to/further away from the camera; repeat the phrase “The quick brown fox jumps over the lazy dog” (or any other phrase). These prompts may be displayed by the VA on a display of the Subject's EUA. Alternatively, they may be voice prompts caused by the VA in the Subject's EUA. The Subject's EUA then transmits the recorded video data back to the Authentication Server. The server stores the reference video data in its database.

FIG. 3 is a block diagram of a method 300 for facilitated authentication video capture and review in accordance with an embodiment of the present invention. The Authentication Server 108 uses information from a set of API calls that have been made from the computer system of the Custodian 104 and/or the computer system of the Subject 102 and/or information from the database to cause a set of prompts to be presented to the Subject. These prompts are presented through a EUA 304 running on a computing device of the Subject, for example by a Virtual Assistant. The Authentication Server 108, through the EUA 304, then causes recording of time-marked video data of the responses of the Subject. This video data is transmitted to the Authentication Server 108 and stored in the database. The Authentication Server 108 then initiates an authentication request to an Authentication Agent, who may be a Trusted Contact or a Third Party. The request is received by and presented through a EUA 306 of the Authentication Agent, for example by a Virtual Assistant. The Virtual Assistant executing on the EUA 306 of the Authentication Agent may prompt the Authentication Agent to respond to the authentication request. If the Authentication Agent accepts the authentication request, the server 108 transmits the video data to the EUA 306 and causes display of the video data on the Authentication Agent's computing device through the EUA 306. The Authentication Server 108 then receives a set of authentication evaluation responses from the Authentication Agent that have been collected through the EUA 306, for example by the Virtual Assistant. These authentication evaluation responses are described in further detail below. After having received the authentication evaluations, the Authentication Server 108 determines an authentication result, which may be based on a confidence score.

### Authentication Video Capture

The objective of the facilitated video capture is twofold: establish that the video is authentic, i.e. not a “deepfake”; and verify that the Subject is indeed who they claim to be. The Subject's VA in the EUA running on the Subject's computing device displays and guides the Subject through a set of prompts that accomplish these goals. These prompts are determined and caused by the Authentication Server. Examples for prompts include: state your full name; state the current date and time; state where you are; state what can be seen in the background; repeat the following phrase. The phrase to be repeated may consist of several randomly selected words, e.g. “fast purple dog.” The phrase could also be a numerical sequence such as “4293.” The phrase is generated by the Authentication Server and is unique to the current authentication session.

Other examples of prompts that the Authentication Server may cause the Subject's EUA to give to the Subject are prompts to perform physical actions, such as: turn to the left/right; look up/down; move your hand slowly in front of your face from one side to the other. If the current authentication mode is authentication by Trusted Contact, additional examples of prompts are: state the full name of the person who is providing verification; state something that is known to you and the person who is verifying you, but would not easily be guessed by others, such as where you last saw each other, upcoming plans, or information about a shared interest such as a sports team; state the word or phrase that you have agreed upon with the person who is verifying you (if one has been specified).

The exact combination and order of these prompts is determined by the Authentication Server and varies depending on the authentication mode, history of authentications, previous responses, and parameters that have been set by the Custodian and/or the Subject. Video data of the prompts and the Subject's responses to these prompts are recorded by the EUA on the Subject's computing device.

The time point on the video timeline of each prompt, as well as the time point of the ensuing response, is recorded by the Authentication Server, or by the Subject's EUA and transmitted to the Authentication Server, in order to facilitate synchronized review.

The result of the authentication video capture is a set of video clips that can be used to authenticate the Subject, based on automated technical analysis and/or review by the Authentication Agent. These video clips are transmitted to the Authentication Server and are stored in the database.

### Review of Video by Authentication Agent

If a human Authentication Agent performs the review function, the video and accompanying audio that has been recorded by the Subject is presented to the Authentication Agent in a video playback frame on the Authentication Agent's computing device. While the video and accompanying audio is stored in a database and presented to the Authentication Agent as retrieved from the database, it is expressly contemplated that the capture of the authentication video and the review of the video by the Authentication Agent is performed substantially in real-time. For example, the authentication video and accompanying audio may be transmitted to the Authentication Server while it is being captured, and the Authentication Server may transmit the video and audio to the Authentication Agent's computing device immediately after receipt, at the same time as it is being stored in the database.

The process is guided by a VA in the Authentication Agent's EUA 306. The process is time-synchronized with the prompts that were issued to and responses that were received from the Subject, and the process is caused by the Authentication Server 108. The Authentication Agent is asked for a set of authentication evaluation responses in response to having reviewed the recorded video. The Authentication Server 108 causes the EUA 306 to play a part of the authentication video, retrieved from the database and transmitted to the EUA running on the Authentication Agent's computing device, that includes a prompt and a response of the Subject to that prompt. The display of the video may be caused by use of the VA in the EUA 306. The playback of the video then pauses, and the Authentication Agent, in an authentication evaluation request that may, for example, be displayed by the VA, is asked for an authentication evaluation response that corresponds to the prompt and response. Examples for such authentication evaluation requests are:
If the Subject was asked to state their full name, the Authentication Agent is asked “did [Subject] state their name correctly?”
If the Subject was asked to state the date and time, the Authentication Agent is asked “did [Subject] state the current date and time correctly?”
If the Subject was asked to speak the phrase “fast purple dog,” the Authentication Agent is asked “which phrase did [Subject] say: “little red zebra,” “furry white turtle”,” or “fast purple dog”?
If the Subject was asked to turn to the left/right, or look up/down, the Authentication Agent is asked “did they [turn to the left/right|look up/down]?”

If the Authentication Agent is a Trusted Contact, further examples of authentication evaluations are:
If the Subject was asked to state something personal known to them and the Authentication Agent, the Authentication Agent is asked “did [Subject] refer to something that you know about?”
If the Subject and the Authentication Agent have agreed on a shared secret word or phrase, the Authentication Agent is asked “did [Subject] state your shared secret word or phrase?”
How confident are you overall that this was [Subject]? (the Authentication Agent chooses a value from 1 to 5, with 1 meaning least confident and 5 meaning most confident)

If the Authentication Agent is a Third Party, further examples of authentication evaluation requests are:
A video playback frame containing the reference video is displayed side by side with the video playback frame containing the authentication video. Snippets of each video are played sequentially, for example the Subject speaking their name, or turning to the left/right. After playback of each snippet, the Authentication Agent is asked “how similar does [Subject] appear and sound in the two videos?” (the Authentication Agent chooses a value from 1 to 5, with 1 meaning least similar and 5 meaning most similar)

Additionally, the Authentication Agent, whether Trusted Contact or Third Party, may be asked to make a set of overall assessments of the authentication video by answering questions such as:
How clear was the video and audio? (the Authentication Agent chooses a value from 1 to 5, with 1 meaning least clear and 5 meaning clearest)
Did you notice any discontinuities or unusual patterns in the video?
Was there anything in the video that seemed inauthentic or suspicious?

After the video review is completed, the resulting authentication evaluation responses given by the Authentication Agent in the response to the authentication evaluation requests are sent back to the Authentication Server, for example by an API call. The authentication evaluation responses may be collected by the VA on the Authentication Agent's VA 306. The VA may also transmit the authentication evaluation responses back to the Authentication Server.

Based on some or all of the Authentication Agent's authentication evaluation responses for each of the prompts and some or all of the overall assessments, the Authentication Server may produce an overall percentage-based confidence score. This score may be calculated by multiplying a numerical representation of each response by pre-configured parameters that assign a weight to each of the criteria, combining them into a weighted average, and scaling to a percentage. For example, if the Subject provided all of the requested information correctly, but the quality of the video and the audio were low, this may result in an overall score of 45, whereas if the quality of the video and the audio were high, and the Subject answered all questions correctly, but turned to the left instead of right, this may result in an overall score of 90. The pre-configured parameters may be stored in and retrieved from the database.

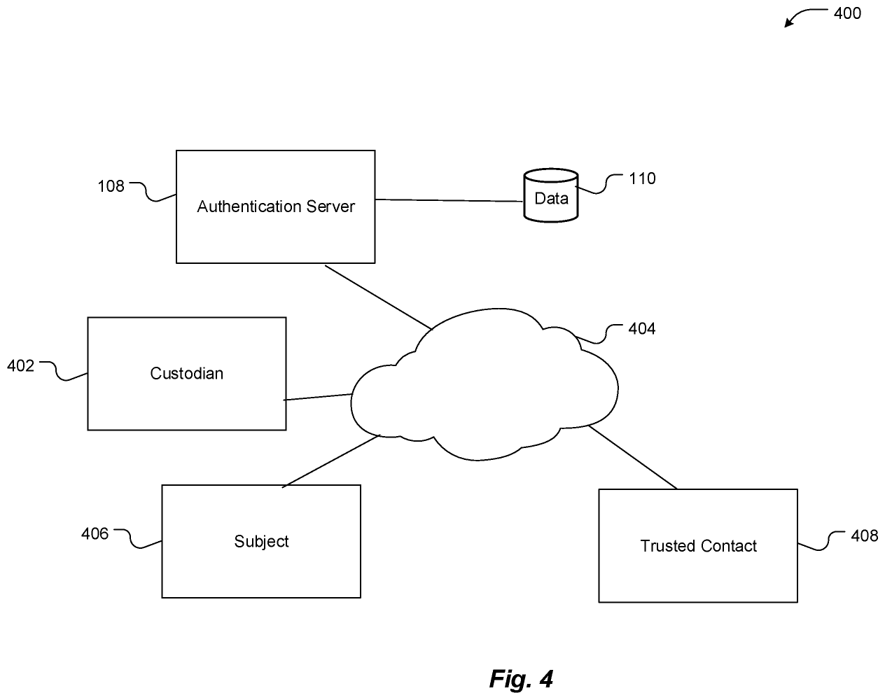

FIG. 4 is a block diagram of an authentication system 400 in accordance with an embodiment of the present invention. The authentication system 400 includes a server system such as the Authentication Server 108 that includes a processor (not shown). The Authentication Server 108 is coupled to a database 110. The Authentication Server 108 is further coupled to a network 404. As described above, the Authentication Server 108 coordinates authentication requests between a computer system of the Custodian 402, a computer system of the Subject 406, and a computer system of the Trusted Contact 408, all of which are also coupled to the network 404. The network 404 therefore allows communication between the Authentication Server 108 and the computer systems, or computing devices, of the Subject, Trusted Contact, and Custodian. As described above, communication between the Authentication Server 108 and the computer system of the Subject 406, the computer system of the Trusted Contact 408, and the computer system of the Custodian 402 may be performed through an API of the Authentication Server.

The Subject's computer system 406 and the Trusted Contact's computer system 408 may be personal computers, laptops, smartphones, tablets, or any other computing device that has a screen and a camera and is directly or indirectly coupled to the network 404. The Subject's computer 406 executes a EUA 304, as described above. Also as described above, the Trusted Contact's computer 408 executes a EUA 306. Both EUAs may include Virtual Assistants. As described above, the Virtual Assistants are components of the respective EUAs 304 and 306. Like the EUAs, they may, for example, be dynamic web applications, standalone applications, or embeddable modules.

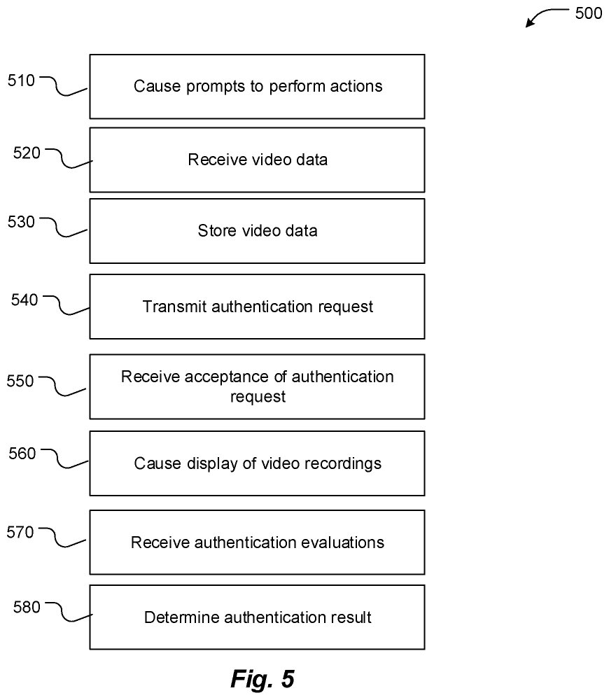

FIG. 5 is a block diagram of an authentication method 500 in accordance with an embodiment of the present invention. The computer-implemented method 500 for authentication by a Trusted Contact includes processes 510-580 carried out by a server system, such as the Authentication Server 108.
In process 510, the server system causes prompts to a subject, such as the Subject, to perform a set of actions. As described above, examples for such actions include stating a current date, stating a current time, stating a name of the subject, stating a current location of the subject, stating information known to the subject and the Trusted Contact, stating a phrase, performing a hand gesture, and performing a head or body movement. Examples of head or body movements include, but are not limited to, bouncing, swaying, blinking of the eyes, nodding and turning of the head or body. The prompts are displayed by a EUA on a computing device of the Subject, for example through a VA. The Subject's computing device also records video data of the Subject performing the actions.
In process 520, the server system receives the video data from the device of the Subject. The video data includes a set of video recordings of the subject performing the set of actions.
In process 530, the server system stores the set of video recordings in a database, such as database 110.
In process 540, the server system transmits an authentication request to a computing device of the Trusted Contact. The authentication request may be transmitted to a VA executing on the computing device of the Trusted Contact. The VA may then prompt the Trusted Contact to respond to and/or accept the authentication request.
In process 550, the server system receives an acceptance of the authentication request from the computing device of the Trusted Contact.
In process 560, the server system causes display of the set of video recordings retrieved from the database on the computing device of the Trusted Contact, together with a set of authentication evaluation requests to evaluate an authenticity of each one of the set of video recordings. The video recordings and the authentication evaluation requests are displayed by a EUA that is executed on the computing device of the Trusted Contact, for example through a VA. The EUA also collects a set of authentication evaluation responses, where each one of the set of authentication evaluation responses is responsive to an authentication evaluations request of the set of authentication evaluation requests.
In process 570, the server system receives the set of authentication evaluation responses from the computing device of the Trusted Contact. The server system may receive the set of authentication evaluation responses from a VA executing on the computing device of the Trusted Contact.
In process 580, the server system determines an authentication result based on the set of authentication evaluation responses.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method for authentication of a subject by a trusted contact, the method including processes carried out by a server system, the processes comprising:
causing, by the server system, prompts to the subject to perform a set of actions, each action in the set of actions selected from the group consisting of stating a current date, stating a current time, stating a name of the subject, stating a current location of the subject, stating information known to the subject and the trusted contact, stating a phrase, performing a hand gesture, performing a head or body movement, and combinations thereof;
receiving, by the server system, video data, the video data including a set of video recordings of the subject performing the set of actions;
storing, by the server system, the set of video recordings in a database;
transmitting, by the server system to a computing device of the trusted contact, an authentication request;
in response to the server system receiving an acceptance of the authentication request from the computing device of the trusted contact:
causing display, by the server system on the computing device of the trusted contact, of the set of video recordings retrieved from the database together with a set of authentication evaluation requests to evaluate an authenticity of each one of the set of video recordings;
receiving, by the server system from the computing device of the trusted contact, a set of authentication evaluation responses, each one of the set of authentication evaluation responses responsive to an authentication evaluation request of the set of authentication evaluation requests; and
determining, by the server system, an authentication result based on the set of authentication evaluation responses.

2. A computer-implemented method for authentication according to claim 1, wherein determining an authentication result includes calculating, by the server system, a confidence score based on the set of authentication evaluation responses.

3. A computer-implemented method for authentication according to claim 1, wherein the receiving video data including the set of video recordings of the subject and the causing display of the set of video recordings on the device of the trusted contact is performed substantially in real-time.

4. A computer-implemented method for authentication according to claim 1, wherein the server system causes the prompts to the subject to perform a set of actions to be displayed on a computing device of the subject.

5. A computer-implemented method for authentication according to claim 4, wherein the server system causes the display of the prompts by use of a virtual assistant executing on the computing device of the subject.

6. A computer-implemented method for authentication according to claim 1, wherein the server system transmits the authentication request to a virtual assistant executing on the computing device of the trusted contact.

7. A computer-implemented method for authentication according to claim 6, further comprising prompting, by the virtual assistant executing on the computing device of the trusted contact, the trusted contact to accept the evaluation request.

8. A computer-implemented method for authentication according to claim 1, wherein the server system causes the display of the video recordings retrieved from the database on the computing device of the trusted contact by use of a virtual assistant executing on the computing device of the trusted contact.

9. A computer-implemented method for authentication according to claim 1, wherein the server system causes the display of the set of authentication evaluation requests by use of a virtual assistant executing on the computing device of the trusted contact.

10. A computer-implemented method for authentication according to claim 1, wherein the server system receives the set of authentication evaluation responses from a virtual assistant executing on the computing device of the trusted contact.

11. A system for authentication of a subject by a trusted contact, the system comprising:
a server system including a processor, the server system coupled to a database, the server system further coupled to a computing device of the trusted contact over a network; wherein the processor is configured to
cause prompts to the subject to perform a set of actions, each action in the set of actions selected from the group consisting of stating a current date, stating a current time, stating a name of the subject, stating a current location of the subject, stating information known to the subject and the trusted contact, stating a phrase, performing a hand gesture, performing a head or body movement, and combinations thereof;
receive video data, the video data including a set of video recordings of the subject performing the set of actions;
store the set of video recordings in the database;
transmit, to the computing device of the trusted contact, an authentication request;
in response to receiving an acceptance of the authentication request from the computing device of the trusted contact:
cause display, on the computing device of the trusted contact, the set of video recordings retrieved from the database together with a set of authentication evaluation requests to evaluate an authenticity of each one of the set of video recordings;
receive, from the computing device of the trusted contact, a set of authentication evaluation responses, each one of the set of authentication evaluation responses responsive to an authentication evaluation request of the set of authentication evaluation requests; and
determine an authentication result based on the set of authentication evaluation responses.

12. A system for authentication according to claim 11, wherein determining an authentication result includes calculating a confidence score based on the set of authentication evaluation responses.

13. A system for authentication according to claim 11, wherein the processor is configured to receive video data including the set of video recordings of the subject and to cause display of the set of video recordings on the device of the trusted contact substantially in real-time.

14. A system for authentication according to claim 11, further comprising a computing device of the subject coupled to the server system over the network, wherein the processor is configured to cause the prompts to the subject to perform a set of actions to be displayed on the computing device of the subject.

15. A system for authentication according to claim 14, further comprising a virtual assistant executing on the computing device of the subject, wherein the processor is configured to cause the display of the prompts by use of the virtual assistant executing on the computing device of the subject.

16. A system for authentication according to claim 11, further comprising a virtual assistant executing on the computing device of the trusted contact, wherein the processor is configured to transmit the authentication request to the virtual assistant executing on the computing device of the trusted contact.

17. A system for authentication according to claim 16, wherein the processor is further configured to cause a prompt, by the virtual assistant executing on the computing device of the trusted contact, to he trusted contact to accept the evaluation request.

18. A system for authentication according to claim 11, further comprising a virtual assistant executing on the computing device of the trusted contact, wherein the processor is configured to cause the display of the video recordings retrieved from the database by use of the virtual assistant executing on the computing device of the trusted contact.

19. A system for authentication according to claim 11, further comprising a virtual assistant executing on the computing device of the trusted contact, wherein the processor is configured to cause the display of the set of authentication evaluation requests by use of the virtual assistant executing on the computing device of the trusted contact.

20. A system for authentication according to claim 1, further comprising a virtual assistant executing on the computing device of the trusted contact, wherein the processor is configured to receive the set of authentication evaluation responses from the virtual assistant executing on the computing device of the trusted contact.
